(19) United States
(12) Patent Application Publication
(10) Pub. No.: US 2020/0204864 A1
(43) Pub. Date: Jun. 25, 2020

(54) CLASSIFICATION OF IMAGES BASED ON STATIC COMPONENTS

(71) Applicant: Caavo Inc, Milpitas, CA (US)

(72) Inventors: Ashish D. Aggarwal, Stevenson Ranch, CA (US); Neha Mittal, Bangalore (IN); Aakash Maroti, Murshidabad (IN)

(21) Appl. No.: 16/721,555

(22) Filed: Dec. 19, 2019

(30) Foreign Application Priority Data
Dec. 20, 2018 (IN) 201841048256

(51) Int. Cl. H04N 21/4728; G06F 16/55; H04N 21/4725; H04N 21/4402; H04N 21/485

(52) U.S. Cl. CPC H04N 21/4728; G06F 16/55; H04N 21/4854; H04N 21/440245; H04N 21/4725

(57) ABSTRACT

Methods, systems, and apparatuses are described for generating an image stencil for a media device. A plurality of image frames from the media device may be obtained. Each of the image frames is converted to a reduced image frame, to generate a plurality of reduced image frames. Different regions of interest are identified across the reduced image frames. One region of interest may include one or more areas that are static across the reduced image frames. Another region of interest may include one or more areas that are dynamic across the reduced image frames. An image stencil may be generated using the regions of interest, where the image stencil is opaque in regions that are static across the image frames, and transparent in other regions that are dynamic across the reduced image frames. The image stencil may be stored, along with an identifier of the media device.

### CROSS-REFERENCE TO RELATED APPLICATIONS

This application claims foreign priority to Indian Patent Application No. 201841048256, titled “Classification of Images Based on Static Components,” filed on Dec. 20, 2018, the entirety of which is incorporated by reference herein.

### BACKGROUND

### Technical Field

The subject matter described herein relates to the classification of images based on static image components.

### Description of Related Art

A home entertainment system may comprise many different audio/video (AV) devices coupled together by a home entertainment hub and/or connected to a television (TV) or high definition TV (HDTV). These AV devices may include, for example, a cable/satellite TV set top box (STB), an audio system, a Blu-ray® or DVD (digital versatile disc) player, a digital media adapter, a game console, a multimedia streaming device, etc. Each device is typically connected to the hub or television through a cable, such as a High Definition Multimedia Interface (HDMI) cable. Given the ever-growing number of devices in a system, the number of cables is increasing, leading to difficulty in tracking which AV device is coupled to each input of the hub or television.

Furthermore, even where a user is aware of the mapping of devices to input ports, the user may still need to manually configure each input port of the hub or television to identify a device type or name to allow the user to easily determine the device mapping. Configuring a system in this manner can be cumbersome, often requiring a time-consuming setup process for the user when setting up a new entertainment system or making changes to an existing system.

### BRIEF SUMMARY

Methods, systems, and apparatuses are described for the identification of devices in a media system such as a home entertainment system. In particular, image frames provided by media devices are captured. The captured images are classified based at least on static image components, and the classification may be used in identifying the media devices.

In one aspect, an image stencil may be generated for a media device. A plurality of image frames from the media device are obtained. Each of the image frames is converted to a reduced image frame, to generate a plurality of reduced image frames. Different regions of interest are identified across the reduced image frames. One region of interest may include one or more areas that are static across the reduced image frames. Another region of interest may include one or more areas that are dynamic across the reduced image frames. An image stencil may be generated using the regions of interest, where the image stencil is opaque in regions that are static across the image frames, and transparent in other regions that are dynamic across the reduced image frames. The image stencil may be stored, along with an identifier of the media device from which the image frames were initially obtained.

In another aspect, a media device may be identified using an image stencil. For instance, an image frame may be obtained from the media device by another device, such as a media device hub. The obtained image frame may be converted to a reduced image frame. The reduced image frame may be compared with each of a plurality of image stencils. In some implementations, each image stencil may comprise at least one static image region that is opaque and at least one dynamic image region that is transparent. It may be determined that the reduced image frame matches a particular stencil, and in such an instance, the media device may be identified based on a device identifier associated with the matched image stencil.

Further features and advantages, as well as the structure and operation of various embodiments, are described in detail below with reference to the accompanying drawings. It is noted that implementations are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 depicts a block diagram of media system containing a static image classification system in accordance with example embodiments described herein.

FIG. 2 is a flowchart of a method for generating an image stencil, according to an example embodiment.

FIG. 3 depicts a block diagram of system for generating a stencil in accordance with example embodiments described herein.

FIG. 4 is a flowchart of a method for identifying a media device, according to an example embodiment.

FIGS. 5A-5C depict illustrative image frames comprising dynamic and static components, in accordance with example embodiments described herein.

FIGS. 6A-6C depict illustrative image frames after applying one or more image processing techniques, in accordance with example embodiments described herein.

FIG. 7 depicts an illustrative image stencil comprising static regions and a dynamic region, in accordance with example embodiments described herein.

FIG. 8 depicts an additional illustrative image stencil comprising static regions and dynamic regions, in accordance with example embodiments described herein.

FIG. 9 is a block diagram of an example computer system in which example embodiments may be implemented.

Embodiments will now be described with reference to the accompanying drawings.

### DETAILED DESCRIPTION

### I. Introduction

The present specification discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Techniques are described herein to generate image stencils that may be used to classify screen images and associated media devices. For example, a plurality of image frames from a media device are obtained. The plurality of image frames may originate from the same media device (such as a particular brand, make, model, and/or type of media device). Each image frame may comprise a screen image (e.g., an image representing a graphical user interface (GUI) of a media device or other device). In some implementations, the image frames may include one or more home screen images or menu screen images that may comprise one or more static image elements (e.g., image elements that may be the same across the plurality of image frames) and one or more dynamic image elements (e.g., image elements that may be different across different image frames).

In some implementations, each of the image frames is converted to a reduced image frame, to generate a plurality of reduced image frames. Different regions of interest are identified across the reduced image frames. A first region of interest may include one or more areas that are static across the reduced image frames. Another region of interest may include one or more areas that are dynamic across the reduced image frames. An image stencil may be generated that is segmented such that it includes one or more transparent regions outside of the static image region or regions. For instance, the image stencil may be generated where the image stencil is opaque in regions that are static across the image frames, and transparent in other regions that are dynamic across the reduced image frames. The image stencil may be stored, along with an identifier, such as a media device identifier (e.g., the media device from which the image frames originated). In this manner, an image stencil may thereby be generated and stored that is unique to a particular media device.

In some other implementations, an image frame may be classified in accordance with techniques described herein. For instance, a media device may be identified using an image stencil. An image frame may be obtained from the media device. In some examples, the image frame may be obtained by a device hub, audio/video receiver (AVR), a TV, HDTV, etc., in a home entertainment system. In some example embodiments, the image frame may comprise a predetermined type of image, such as a home screen image, a menu screen image, etc. The obtained image frame may be converted to a reduced image frame, such as a monochrome image, an image with a reduced resolution, etc. The reduced image frame may be compared with each of a plurality of image stencils. In some implementations, each image stencil may comprise at least one static image region that is opaque and at least one dynamic image region that is transparent. Each image stencil may be compared with the reduced image (e.g., by overlaying, superimposing, or other suitable comparison techniques). It may be determined that the reduced image frame matches a particular stencil. In such an example, the reduced image frame may be classified as belonging to a class of the particular stencil. In other words, the media device from which the image frame was obtained may be identified based on a device identifier (e.g., a brand, make, model, etc.) associated with the matched image stencil In this manner, an obtained image frame of a media device (e.g., a home screen image of the media device) may be classified as belonging to a particular stencil, thereby enabling the media device to be automatically identified by a device identifier associated with the stencil.

### II. Classification of Images Corresponding to Home Entertainment Devices

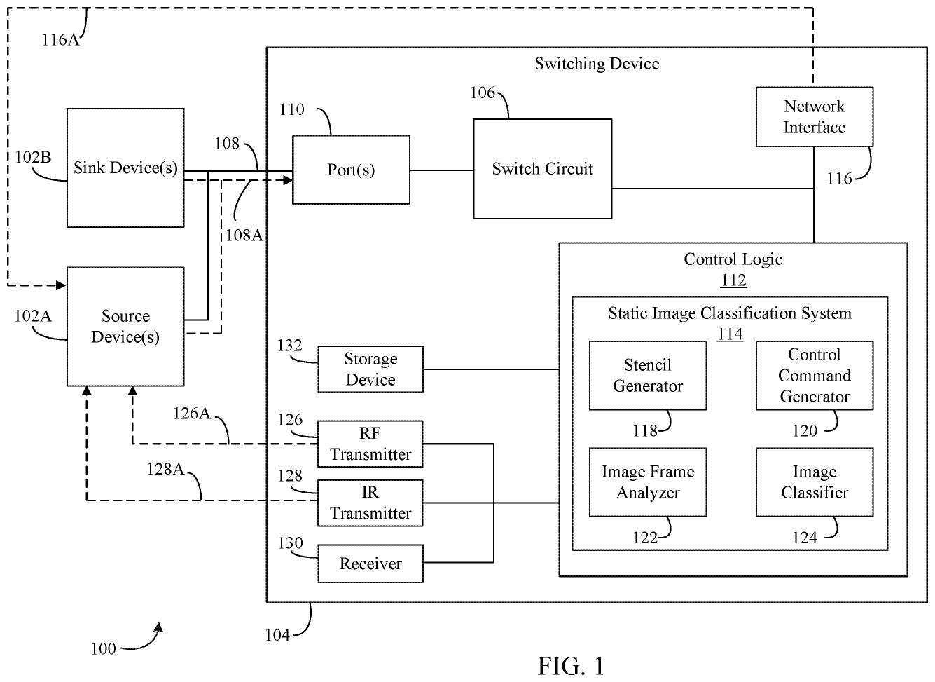

FIG. 1 is a block diagram of an example media system 100 that may be configured to generate an image stencil and/or to classify an image frame, in accordance with example embodiments. As shown in FIG. 1, system 100 includes one or more source or input media device(s) 102A, one or more sink or output media devices 102B, and a switching device 104 (e.g., a multimedia switching device, an AVR, a repeater, etc.).

In the illustrative example of FIG. 1, source device(s) 102A may comprise source devices configured to provide audio and/or video signals. For instance, source device(s) 102A may include a multimedia device, such as a Blu-ray® player, a STB, or a streaming media player. Sink device(s) 102B may include sink devices configured to receive audio and/or video signals, such as a television or a projector. The types of media devices are only illustrative, and source and sink media device(s) 102A and 102B may include any electronic device capable of providing and/or playing back AV signals. In accordance with implementations, source device(s) 102A and/or sink device(s) 102B may comprise another switching device (e.g., a device similar to switching device 104), hub, home entertainment system, AVR, etc. to increase a number of connected devices.

As shown in FIG. 1, switching device 104 includes one or more AV port(s) 110, a switch circuit 106, control logic 112, a network interface 116, an RF transmitter 126, an IR transmitter 128, a receiver 130, and a storage device 132. Control logic 112 includes a static image classification system 114. As further shown in FIG. 1, source devices 102A and/or sink device(s) 102B is/are coupled to AV port(s) 110. In embodiments, source devices 102A and/or sink device(s) 102B may be coupled to AV port(s) 110 via an HDMI cable 108.

Port(s) 110 may be further configured to receive and/or transmit audio and/or video information between source device(s) 102A, switching device 104, and/or sink device(s) 102B. In some example embodiments, port(s) 110 may also be configured to transmit control information 108A, such as device information (e.g., Extended Display Identification Data (EDID) and/or HDCP information, or other control information) via cable 108. Furthermore, AV port(s) 110 may be automatically configured to be input AV ports or output AV ports upon connecting electronic device(s) to AV port(s) 110. Accordingly, switching device 104 (and any other switching devices, hubs, etc. to which switching device 104 is coupled) may also act as either an input media device or an output media device. It is noted and understood that the arrangement shown in FIG. 1 is illustrative only, and may include any other manner of coupling devices, such as media devices. Furthermore, it is noted and understood that although switching device 104 is shown in FIG. 1, system 100 may be implemented without switching device 104 in some implementations. For instance, switching device 104 may be implemented in one or more other media devices coupled to a home entertainment system, such as in a TV, HDTV, projector, AVR, etc.

Switch circuit 106 may be configured to connect a particular input AV port (e.g., one of AV port(s) 110) to a particular one or more output AV ports (e.g., another one of AV port(s) 110). Additional details regarding the auto-configuration of AV port(s) may be found in U.S. patent application Ser. No. 14/945,079, filed on Nov. 18, 2015 and entitled “Auto Detection and Adaptive Configuration of HDMI Ports,” the entirety of which is incorporated by reference. Furthermore, additional details regarding the identification of electronic device(s) and the mapping of electronic device(s) to AV port(s) may be found in U.S. Pat. No. 9,749,552, filed on Nov. 18, 2015 and entitled “Automatic Identification and Mapping of Consumer Electronic Devices to Ports on an HDMI Switch,” the entirety of which is incorporated by reference.

System 100 may further comprise a receiver 130 configured to receive command(s) that indicate that a user would like to use one or more of media device(s) 102A or 102B for providing and/or presenting content. In accordance with an embodiment, receiver 130 may receive control signals via a wired connection (e.g., via a Universal Serial Bus (USB) cable, a coaxial cable, etc.). In accordance with another embodiment, the control signals may be received via a wireless connection (e.g., via infrared (IR) communication, radio frequency (RF) communication (e.g., Bluetooth™, as described in the various standards developed and licensed by the Bluetooth™ Special Interest Group, technologies such as ZigBee® that are based on the IEEE 802.15.4 standard for wireless personal area networks, near field communication (NFC), other RF-based or internet protocol (IP)-based communication technologies such as any of the well-known IEEE 802.11 protocols, etc.) and/or the like.

In accordance with an embodiment, a control device (not shown in FIG. 1) may transmit control signals to receiver 130. For example, the control device may be a remote-control device, a desktop computer, a mobile device, such as a telephone (e.g., a smart phone and/or mobile phone), a personal data assistance (PDA), a tablet, a laptop, etc. In accordance with another embodiment, the control device is a dedicated remote-control device including smart features such as those typically associated with a smart phone (e.g., the capability to access the Internet and/or execute variety of different software applications), but without the capability of communicating via a cellular network.

The control device may be enabled to select a source device and/or a sink device that for providing and/or presenting content. After receiving a selection (e.g., from a user), the control device may transmit a command to receiver 130 that includes an identifier of the selected source and/or sink devices. The identifier may include, but is not limited to, the type of the electronic device (e.g., a Blu-ray player, a DVD player, a set-top box, a streaming media player, a TV, a projector etc.), a brand name of the electronic device, a manufacturer of the electronic device, a model number of the electronic device, and/or the like.

Receiver 130 may also be configured to receive one or more voice commands from a user that indicate one or more electronic device(s) (e.g., source media devices 102A and/or sink media device(s) 102B) that a user would like to use for providing and/or presenting content. For example, the user may utter one or more commands or phrases that specify electronic device(s) that the user would like to use (e.g., “Watch DVD,” “Watch satellite TV using projector,” “Turn on streaming media device”). The command(s) may identify electronic device(s) by one or more of the following: a type of the electronic device, a brand name of the electronic device, a manufacturer of the electronic device, a model number of the electronic device and/or the like. In accordance with an embodiment, receiver 130 may comprise a microphone configured to capture audio signals. In accordance with such an embodiment, receiver 128 and/or another component of switching device 104 is configured to analyze audio signals to detect voice commands included therein. In accordance with another embodiment, the microphone is included in the control device. In accordance with such an embodiment, the control device is configured to analyze the audio signal received by the microphone to detect voice command(s) included therein, identify the electronic device(s) specified by the user, and/or transmit command(s) including identifiers for the identified electronic device(s) to the receiver. After receiving such command(s), receiver 130 provides the identifier(s) included therein to a mapping component (not shown) in control logic 112. Based on the identifier(s) in the mapping component, control logic 112 may be configured to provide a control signal to switch circuit 106, which causes switch circuit 106 to connect the identified source AV port to the identified and/or determined sink AV port.

Switching device 104 may be further configured to transmit a control signal to any of source or sink device(s) 102A or 102B. The control signal may be any type of signal to control one or more source or sink device(s) 102A or 102B, such as a signal to control a navigation, launching of particular interfaces, applications, screens, and/or content, control of a power state, an input, an output, an audio setting, a video setting, or any other setting of source or sink device(s) 102A or 102B. In embodiments, source or sink device(s) 102A and/or 102B may be configured to receive control signals via any one or more communication protocols. For example, as shown in FIG. 1, switching device 104 may transmit to source device(s) 102A an IP control signal 116A via network interface 116, RF control signal 126A via RF transmitter 126, IR control signal 128A via IR transmitter 128, a control signal 108A via an HDMI Consumer Electronics Control (HDMI-CEC) protocol over HDMI interface 108, or via any other suitable communication protocol or interface.

RF transmitter 126 may transmit an RF control signal via any suitable type of RF communication (e.g., Bluetooth™, as described in the various standards developed and licensed by the Bluetooth™ Special Interest Group, technologies such as ZigBee® that are based on the IEEE 802.15.4 standard for wireless personal area networks, near field communication (NFC), other RF-based or internet protocol (IP)-based communication technologies such as any of the well-known IEEE 802.11 protocols, etc.), and/or the like. IR transmitter 128 may transmit an IR control signal 128A using any suitable IR protocol known and understood to those skilled in the art.

As shown in FIG. 1, port(s) 110 may be further configured to transmit control signal 108A to source device(s) 102 using an HDMI-CEC communication protocol. Although it is described herein that control signal 108A may be transmitted using an HDMI-CEC communication protocol, it is understood that control signal 108A may include any other suitable transmission over the HDMI cable interface, or any other signaling protocol available with other types of audio/video interfaces.

Network interface 116 is configured to enable switching device 104 to communicate with one or more other devices (e.g., input or output media device(s) 102A or 102B) via a network, such as a local area network (LAN), wide area network (WAN), and/or other networks, such as the Internet. In accordance with embodiments, network interface 116 may transmit an IP control signal 116A over the network to control one or more functions of source device(s) 102A. Network interface 116 may include any suitable type of interface, such as a wired and/or wireless interface.

Static image classification system 114, as shown in FIG. 1, includes a stencil generator 118, a control command generator 120, an image frame analyzer 122, and an image classifier 124. Stencil generator 118 may be configured to generate an image stencil for an image, such as an image representing a GUI of a media device. For instance, each type of media device (e.g., each brand, make, or model) may comprise one or more screens/images of a GUI that include one or more static and/or dynamic image elements. In implementations, stencil generator 118 may be configured to generate an image stencil using one or more images obtained from such a media device that includes one or more regions of interest that may include static regions and dynamic regions.

As used herein, a static image region may include any image element (e.g., portions, areas, objects, individual pixels or collections of pixels, etc.) of an image frame that is identical to each instance of display of the element on a display screen, or graphically varies between instances of such display by less than a predetermined amount (e.g., a predetermined number of different pixels, different color values, hues, contrast, etc.), for each different rendering of the screen in which the image element is presented (e.g., a particular type of GUI screen). In other words, static image regions comprise elements that are represented by the same graphical information (or graphical information that does not vary less than a predetermined amount) in the same location (e.g., based on pixel coordinates of an image frame) across different renderings of the same type of graphical screen (e.g., based on the same screen conditions and/or attributes). In contrast, dynamic image regions may include any image element of an image frame that is not identical to each instance of display of the element on a display screen, or graphically varies between instances of such display by more than the predetermined amount, for each different rendering of the screen in which the image element is presented. Stated differently, dynamic image regions include elements that are graphically different or appear in different locations across different renderings of the same type of graphical screen (e.g., based on the same screen conditions and/or attributes). As an illustrative example, an icon or logo that appears in the same location (e.g., same pixel coordinates) and represented by the same pixel values of a particular type of GUI screen as other renderings of the same type of GUI screen may be identified as static image elements, while a location of the GUI screen where different icons are presented when the GUI screen is re-rendered may be identified as dynamic image elements.

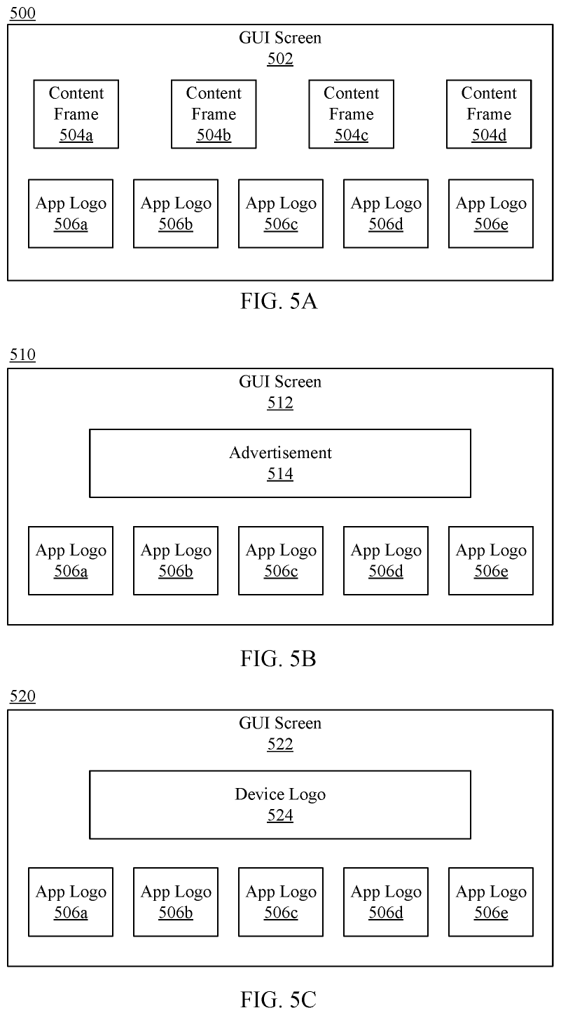

The static image regions may be opaque in the image stencil, and the dynamic image regions may be transparent. As discussed in greater detail below, the transparent regions may comprise an alpha channel or the like in the regions of the image stencil that are identified as dynamic image regions. Illustrative examples for generating stencils from screens of a media device are described in greater detail below with respect to FIGS. 5A-5C, 6A-6C, 7, and 8.

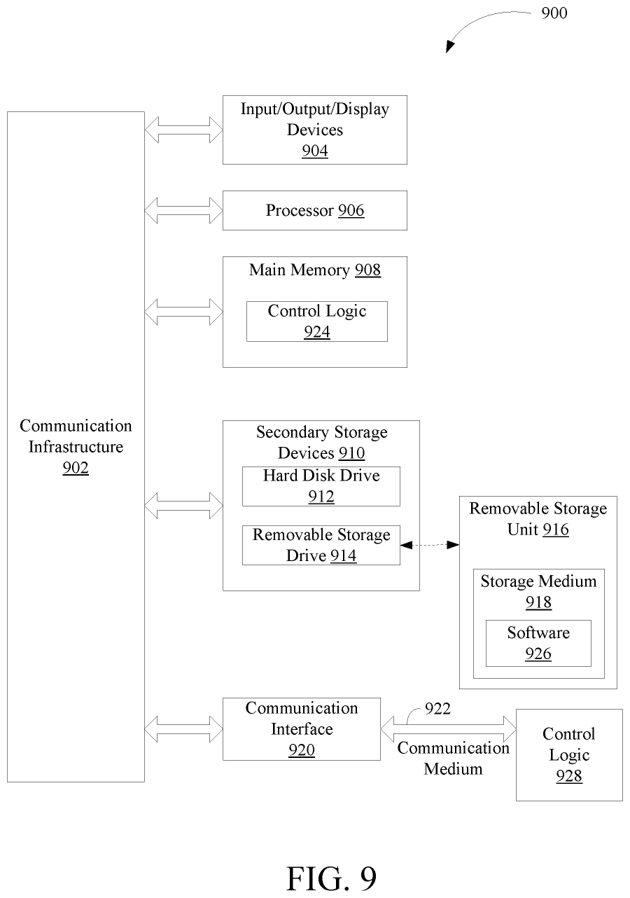

Image stencils generated in accordance with example embodiments may be stored on storage device 132. Storage device 132 may be one or more of any storage device described herein, such as, but not limited to, those described below with respect to FIG. 9. Storage device 132 may include a storage for storing image stencils, as described herein. In some implementations, storage device 132 may also be configured to store a device identifier associated with the image stencil that may identify the media device to which the image stencil relates. In embodiments, storage device 132 may be local (e.g., within switching device 104 or on a device local to switching device 104, such as an external storage device), or remote (e.g., on a remote device, such as a cloud-based system).

Control command generator 120 may be configured to generate one or more commands for transmission to a coupled media device, such as any of source device(s) 102A. In examples, control command generator 120 may generate commands to cause any of source device(s) 102A to launch or navigate to a particular screen, such as a home screen, a menu screen, a guide screen, a screen comprising a listing of recorded content, a screen listing accessible resources (e.g., applications), or any other screen of a source device that may comprise a static image element or expected to comprise a static image element. As described earlier, a static image element may comprise an element that is graphically the same (both in substance and in its location on an image frame), or varies by less than a predetermined amount (e.g., based on a predetermined number of pixels, color values, hues, contrast, etc.) across different renderings of the same screen type. For instance, the static image element may comprise a logo, an icon (e.g., a gear icon indicating a settings menu), text, graphics, or a screen layout (e.g., a particular structure or arrangement of icons or elements, such as a grid pattern or the like) that does not change each time the particular screen of the GUI is accessed and rendered. In one illustrative example, a static image element may include a logo in a corner of a home screen. Even if other elements (such as the identification or arrangement of applications) on the home screen may change each time the home screen is rendered, the logo may appear in the same or graphically similar manner (in terms of location, color, size, etc.). This illustrative embodiment is not intended to be limiting, and other examples are contemplated and will be described in greater detail herein.

Image frame analyzer 122 may be configured to compare an image obtained from a coupled device (e.g., one of source devices 102A) with a set of image stencils. For example, the obtained image may comprise an image of the GUI of a source device on a predetermined screen type, such as a home screen or menu screen. In some examples, the image may be obtained in response to control command generator 120 generating a command to transmit (e.g., via any of the communication protocols described above) to the appropriate one of source device(s) 102A to cause the source device to launch or navigate to a particular GUI screen. Image frame analyzer 122 may compare the obtained image with each image stencil in a set of image stencils. The set of image stencils may comprise, for instance, a collection (e.g., a repository or library) of stencils for each of a plurality of media devices. Each image stencil in the collection or library may correspond to a particular media device (e.g., a particular device brand, make model, etc.). The set of image stencils may be stored locally (e.g., in storage 132 of switching device 104) or remotely (e.g., a cloud-based storage, such as one or more servers that may be accessed via network interface 116). Image frame analyzer may overlay or superimpose the stencil and the obtained image to determine whether the static regions are matching or otherwise exceed a threshold level of resemblance.

Image classifier 124 may be configured to determine whether the obtained image frame (or a reduced image frame, as described herein) corresponds with any of the image stencils in the set of image stencils. For example, upon image frame analyzer 122 comparing the obtained image with a plurality of image stencils, image classifier 124 may determine that a particular image stencil matches the image frame. Where image classifier 124 determines that a particular image stencil matches to the image frame, the image frame may be classified as belonging to a class associated with the image stencil. For example, if image classifier 124 determines that an image frame obtained from a particular media device whose identity was not known at the time the image frame was obtained (e.g., a DirecTV® set-top box (STB)) corresponds to a stencil associated with the DirecTV® STB, image classifier 124 may classify the connected media device as a DirecTV® STB. In this manner, the coupled media device may be automatically classified and identified. The classification may be used, for instance, by switch circuit 106 to map port(s) 110 to an appropriate device identifier.

It is noted and understood that the arrangement shown in FIG. 1 is illustrative only and not intended to be limiting. For instance, static image classification 114 may include one or more additional subcomponents or include less than illustrated subcomponents shown in FIG. 1. In some implementations, stencil generator 118 may be implemented in a separate device, on a server, a management console, etc. located separate and/or remote from switching device 104. In such implementations, stencil generator 118 may transmit, e.g., via a network interface (similar to network interface 116 described herein), one or more generated image stencils (individually or as a collection) to various other devices such as switching device 104 (or any other type of device where one or more components of static image classification system 114 may be implemented), thereby enabling static image classification system 114 to automatically identify coupled devices using the obtained image stencils.

A. Generation of Image Stencils

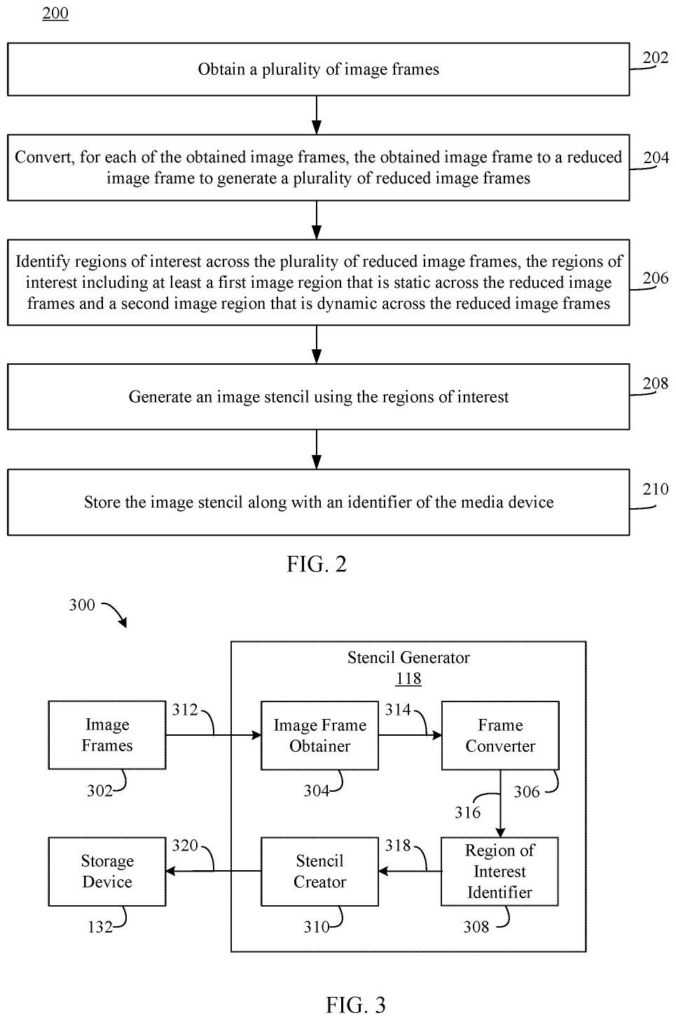

FIG. 2 depicts a flowchart 200 of an example method for generating an image stencil, according to an example embodiment. The method of flowchart 200 may be carried out by stencil generator 118, although the method is not limited to that implementation. For instance, the steps of flowchart 200 may be carried out by any media device (e.g., a device acting as a source media device such as a streaming media device or a gaming console, a TV or HDTV, an AVR, a repeater, a switching device, a management console, a server, etc.). For illustrative purposes, flowchart 200 and stencil generator 118 will be described as follows with respect to FIG. 3. FIG. 3 shows a block diagram of a system 300 for generating an image stencil, according to an example embodiment. System 300 comprises an example implementation of stencil generator 118 and storage device 132. System 300 may also comprise a plurality of image frames 302 obtained from a media device (e.g., a source media device such as a STB, a streaming media player, etc.). Stencil generator 118, as shown in FIG. 3, includes an image frame obtainer 304, a frame converter 306, a region of interest identifier 308, and a stencil creator 310. Other structural and operational embodiments will be apparent to persons skilled in the relevant art(s) based on the discussion regarding flowchart 200, system 100 of FIG. 1, and system 300 of FIG. 3.

As shown in FIG. 2, the method of flowchart 200 begins with step 202. In step 202, a plurality of image frames is obtained. For instance, with reference to FIG. 1, image frame obtainer 304 may be configured to obtain 312 a plurality of image frames 302 from a source media device. Image frame obtainer 304 may obtain image frames 302 via a suitable video interface, such as HDMI cable 108 or any other appropriate video interface. In example embodiments, each image frame of image frames 302 may comprise an image representing a GUI screen of a media device, such as one of source device(s) 102A.

For instance, image frames 302 may each comprise images obtained from the same type of GUI screen and/or images obtained from the same device. In examples, the plurality of image frames 302 may comprise a plurality of images of a GUI screen of a source media device rendered at different times. The GUI screen may include a predetermined type of screen of the source media device, such as a home screen, a menu screen, a guide screen, a screen where pre-recorded multimedia content is listed, or any other type of screen where certain types of image elements (e.g., static and/or dynamic elements) are expected to be present. In implementations, since the content displayed on a particular type of GUI screen (e.g., a home screen) may not be the same at different times, the obtained image frames may therefore include images that comprise various types of image elements, such as static image elements or components that are identical across each of the image frames or do not vary by more than a predetermined amount across renderings of the same type of GUI screen. Such obtained image frames may also include dynamic image elements that include elements that are not the same or vary by more than a predetermined amount across different renderings of the same type of GUI screen. For instance, a dynamic image element may include a presentation of list of content offerings on a home screen that may change (e.g., reordered, replaced with different content offerings, etc.) each time the home screen is rendered. It is noted that example embodiments are not limited to capturing a home screen, but may include capturing any other screen representing a particular GUI screen of a media device, or any other image of the media device that includes both static and dynamic elements.

In step 204, for each of the obtained image frames, the obtained image frame is converted to a reduced image frame to generate a plurality of reduced image frames. For instance, with reference to FIG. 3, frame converter 306 may obtain 314 each of the image frames from image frame obtainer 304 and convert each image frame to a reduced image frame to generate a plurality of reduce image frames. Frame converter 306 may convert each image frame to a reduced image frame in various ways. For instance, frame converter 306 may implement any number of image optimization or processing techniques that may improve the accuracy and performance of the generated image stencil. For instance, frame converter 306 may be configured to convert each of the image frames to monochrome (e.g., black and white) image, and/or perform a thresholding operation to reduce redundant pixel information from the image frames. For example, converting the images frames to black and white may result in a generated stencil that is color agnostic, thereby reducing the computational processing resources utilized when applying the stencil to classifying subsequently obtained image frames, improving the accuracy, and making the image classification techniques described herein more robust. In some further implementations, a plurality of different techniques to convert an image into a monochrome image may be implemented, thereby further increasing the reusability and generalization of a generated stencil, which may also enhance performance when classifying images.

In some other examples, frame converter 306 may be configured to perform other operations, such as reducing a resolution of the image frame (e.g., scaling the image frame to a reduced resolution, cropping the image frame, etc.) and/or a conversion operation from an image format associated with the image frames from one format (e.g., a YUV image format, a Red Green Blue (RGB) image format, etc.) to another image format (e.g., a PNG format, JPG format, GIF format, etc.). In other implementations, stencil generator may also be configured to perform image compression on the image frames to reduce an image file size. Frame converter 306 may also be configured to combine a plurality of image frames by combining and/or averaging pixel values across the plurality of images, before or after implementing the other processing techniques described herein. Frame converter 306 is not limited to the above described techniques, but may implement any other image processing techniques appreciated by those skilled in the relevant art, or generate an image stencil using raw or native image frames (e.g., without any processing). Other illustrative techniques that may also be implemented by frame converter 306 include, but are not limited to converting the images frames to reduced image frames that remove or reduce color information from the original image frame, compressing the image frame using one or more image compression algorithms, or other techniques that may be appreciated to those skilled in the relevant arts that may result in improved performance.

In step 206, regions of interest are identified across the plurality of reduced image frames, the regions of interest including at least a first image region that is static across the reduced image frame and a second image region that is dynamic across the reduced image frames. For instance, with reference to FIG. 3, region of interest identifier 308 may obtain 316 the reduced image frames and identify regions of interest in the reduced image frames. The regions of interest may comprise several different regions of the reduced image frames. For instance, region of interest identifier 308 may be configured to identify image regions (e.g., areas or portions of the image frames) that are static across the reduced image frames. As described herein, static regions may be identified as regions of the image frames that may include, for example, any area such as a logo, text, graphics, etc., or any combination thereof, that is graphically identical (or does not vary by more than a predetermined amount) in substance and in location across the plurality of reduced image frames. In other words, the static image regions may represent portions of the reduced image frames that do not differ by more than a predetermined amount (e.g., in pixel values) between image frames. For instance, on a home screen or a guide screen, a device logo may appear in a particular location of the screen, irrespective of other regions of the screen that may change as a result of different content offerings or the like that are presented in the image frame. In such an example, the static image region may include the region of the image comprising the device logo that appears in each of the reduced image frames at the same location (or a location that is within a predetermined tolerance) of the image frame. It is noted that the static image regions need not be identical across all images, but rather may be deemed static based on a measure of similarity across the images. For instance, if the size, location, content, colors, etc. (or combination thereof) of a particular region exceed a threshold level of similarity across the plurality of images, the region may be identified as a static image region.

In some implementations, such as where the reduced image frames comprise black and white images, region of interest identifier 308 may be configured to identify regions of interest that are either static or dynamic based on contrast similarities or differences across the reduced image frames. For instance, where the contrast of pixels is the same in each of the reduced image frames, the pixel may be identified as a static pixel. Conversely, where the contrast of pixels is different across any of the image frames, the pixel may be identified as a dynamic pixel. Such techniques may be carried out for all of the pixel to generate regions across the reduced image set that are static or dynamic.

The static image region may comprise a singular region in some implementations, but may also comprise a plurality of image regions (e.g., a region encompassing a logo in one corner of the screen and a particular graphic or collection of text in another region of the images). Static image regions may comprise any shape, including rectangles, circles, etc., may be identified by outlining the static image element (e.g., an outline that surrounds a logo), and/or may be identified by a collection of pixel values and/or pixel coordinates. In other examples, static image regions may also comprise an overall structure or layout of a type of GUI screen (e.g., a grid-like pattern in which icons or other selectable objects appear on the screen).

Region of interest identifier 308 may also be configured to identify one or more regions of interest across the plurality of reduced image frames that are dynamic. As described herein, dynamic regions may include, for example, areas or portions across the reduced image frames that are not static image regions. For instance, dynamic image regions may include areas or portions that are not identical (or vary by more than a predetermined amount) across different image frames of the same type of GUI screen. Examples of dynamic regions of an image frame may include, but are not limited to, areas of an image frame representing a type of GUI screen in which an arrangement of icons appears in a different order each time the type of GUI screen is rendered, areas that display video content (e.g., thumbnails of multimedia content that may be presented on a screen), or other areas where different renderings of the same type of GUI screen result in different content being displayed. It is noted that any number of static image regions and/or dynamic image regions may be identified across the plurality of reduced image frames.

In step 208, an image stencil using the regions of interest is generated. For instance, with reference to FIG. 3, stencil creator 310 may use 318 the regions of interest identified by region of interest identifier 308 to generate an image stencil. Stencil creator 310 may generate an image stencil in various ways. In some examples, stencil creator 310 may generate an image stencil that includes a static image region and a transparent region outside the static image region. In other words, stencil creator 310 may be configured to generate an image stencil in which the image stencil is opaque in at least the first image region (e.g., the static image region) and is transparent in at least the second image region (e.g., the dynamic image region). It is understood that any number of opaque and/or transparent regions may be included in the image stencil generated by stencil creator 310.

In other words, for regions of interest that are identified as static image regions, static image elements (e.g., areas or portions that represent the static image regions, which may be identified by a shape, outline, pixel value, pixel coordinates, etc.) are included in the image stencil as opaque regions of the image stencil, while the image stencil remains transparent at locations that are identified as dynamic image regions (e.g., locations or regions of the images that differ across different renderings of the same type of GUI screen or do not share the same or similar pixels). As a result, a stencil may be generated that comprises static components in an opaque fashion, and removes dynamic components from the set of images by setting those regions as transparent regions.

The transparent image regions (e.g., dynamic image regions) of the image stencil may comprise one or more alpha channels that may be used to express a transparency or opaqueness level for different regions in an image. Accordingly, in implementations, the image stencil may include one or more transparent regions for the dynamic image elements, and one or more non-transparent or opaque regions for static image elements across the plurality of images frames. As described above, opaque and/or transparent regions indicating dynamic elements or components in an image stencil may comprise any shape, may be identified by outlining a dynamic element, and/or may be identified by a collection of pixel values and/or pixel coordinates.

In some examples, stencil creator 310 may generate an image stencil that comprise a plurality of color channels (e.g., four channels), including a red channel representing red pixels in the image, a green channel representing green pixels in the image, a blue channel representing blue pixels in the image (collectively referred to as RGB channels) and an alpha channel that indicates regions (e.g., by pixels, regions, etc.) of the image that may be transparent or semi-transparent. In some example embodiments, the image stencil may comprise a Portable Network Graphics (PNG) image file with one or more alpha channel regions, also referred to as an image file in an RGBa format or color space. Embodiments are not limited to PNG image files, however, and may include any other types of image files or formats, including but not limited to other RGBa image formats, known and appreciated to those skilled in the art that may be used to identify both opaque and/or transparent regions.

As described above, stencil creator 310 may generate an image stencil using regions of interest identified from a plurality of image frames that are similar or from the same class (e.g., the same type of GUI screen, such as a home screen, a menu screen, a guide screen, etc.). In some examples, the plurality of image frames used by stencil generator 118 (e.g., the number of image frames 302 obtained by image frame obtainer 3014) may include any number of image frames, including two image frames, 10 image frames, 100 image frames, or any other number of image frames. For instance, the larger the number of image frames in image frames 302, the more accurate region of interest identifier 308 may be in identifying static and/or dynamic regions across the image frames of the same class of image frames, and therefore the more accurate stencil creator 310 may be in generating an image stencil for the class of image frames.

It is noted, however, that implementations, however, are not limited to stencil generator 118 generating an image stencil from a plurality of image frames. Rather, in some other example embodiments, stencil generator 118 may be configured to generate an image stencil with a single image frame, for instance, by identifying static and dynamic image elements in the image frame (e.g., a structure or layout of a screen may be identified as the static region, while the remainder of the content may be identified as dynamic regions).

In step 210, the image stencil is stored along an identifier of the media device from which the image frames were obtained. For instance, with reference to FIG. 3, stencil creator 310 may be configured to store 320 the generated image stencil in storage device 132, or any suitable storage device or medium, including in switching device 104 and/or remotely (e.g., in a centralized location such as a server or a management console). In some examples, such as where stencil generator 118 is implemented in a centralized location or on a server, stencil generator 118 may store the image stencil at the centralized location and subsequently transmit the image stencil via a network interface for storage (e.g., storage 132) on switching device 104. For instance, in such implementations, a server or other device at the centralized location where the image stencil is generated may “push” the image stencil to media device hubs, such as switching device 104, in which image classification techniques described herein may be implemented to identify media devices.

In example implementations, stencil creator 310 may store the image stencil along with a device identifier of a media device. In implementations, the device identifier may include an identifier of the media device from which the plurality of images was obtained and/or from which the image stencil was generated. In some examples, the device identifier may include an identifier of the media device, such as a source media device that may be part of a home entertainment system like system 100 shown in FIG. 1. The device identifier may include one or more of a device brand, type, make, model, version, or any other information for identifying a device associated with the generated image stencil.

It is also noted and understood that a plurality of different image stencils may comprise the same device identifier. For instance, stencil generator 118 may be configured to generate different stencils for the same media device. In one example, stencil generator 118 may be configured to generate different stencils for the same media device in which the image stencils are generated in different image resolutions or image formats. In other implementations, stencil generator 118 may generate different image stencils for the same media device based on different predetermined GUI screens (e.g., one image stencil for a home screen of the media device, another image stencil for a TV guide screen of the same media device, another image stencil for a menu screen of the same media device, etc.). In yet another implementation, stencil generator 118 may generate a plurality of stencils for each product version (e.g., different hardware and/or software versions) of the same type of media device. In this manner, multiple image stencils may be generated for the same device or type of device, thereby further enhancing the accuracy through which images obtained from media devices may be identified.

In some other embodiments, stencil generator 118 need not generate image stencils from scratch. For instance, stencil generator 118 may be configured to modify and/or update an existing image stencil, such as where the image stencil may no longer work properly (e.g., due a media device update that changes the layout or content of a home screen). In such examples, an existing image stencil that includes the four image channels (i.e., the RGB color channels and the alpha transparency channel) may be combined with one or more new images obtained from the same class. In this manner, an image stencil may be modified and/or updated in an incremental manner to accommodate new images from the same class to further improve the accuracy of the stencil. Furthermore, such updated stencils may be transmitted via network interface 116, or any other communication protocol, to other devices where the stencil may be applied to classify images to identify connected media devices, such as switching device 104 when classifying image frames received from a coupled media device, thereby continuously updating the collection or library of stencils on such devices.

B. Classification of Images

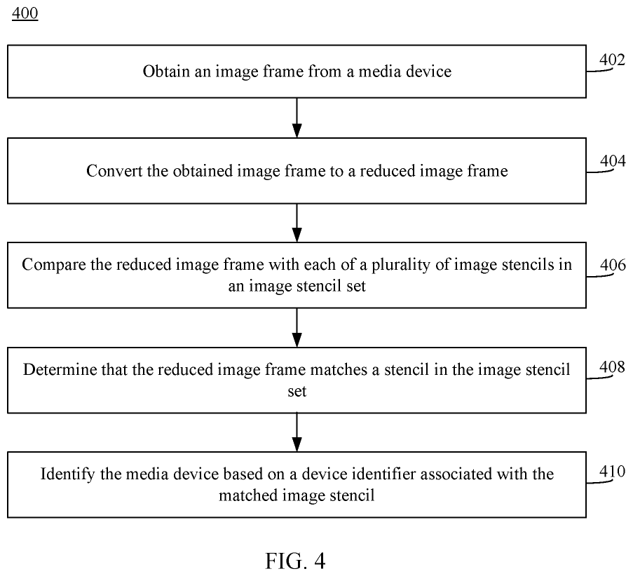

As described above, an image stencil may be used by a media device hub in identifying a media device coupled to the media hub, such as by classifying an image frame as belonging to a class of a stencil. For instance, FIG. 4 depicts a flowchart of a method for identifying a media device, according to an example embodiment The method of flowchart 400 will now be described with reference to the system of FIG. 1, although the method is not limited to that implementation. For instance, the steps of flowchart 400 may be carried out by a suitable media device (e.g., a TV or HDTV, an AVR, a repeater, a switching device, etc.). Other structural and operational embodiments will be apparent to persons skilled in the relevant art(s) based on the discussion regarding flowchart 400 and system 100 of FIG. 1.

As shown in FIG. 4, the method of flowchart 400 begins with step 402. In step 402, an image frame is obtained from a media device. For instance, with reference to FIG. 1, in an illustrative scenario, when an unknown or unidentified device (or a device that has not yet been coupled before) is coupled to switching device 104 for the first time, static image classification system 114 may be configured to classify an image frame obtained from the coupled device. Image frame analyzer 122 may configured to obtain an image frame from a coupled media device, such as one of source device(s) 102A. In examples, the image frame may be obtained via one of port(s) 110 configured to receive an image frame from the source device. The image frame may be obtained via an audio/video coupling, such as an HDMI interface, or other suitable AV coupling as described herein.

The image frame obtained by image frame analyzer 122 may comprise an image frame representing a predetermined type of GUI screen of the source device, such as a home screen, a guide screen, a menu screen, etc. In some examples, the source device 102(A) may be automatically navigated to attempt to navigate the source device to the appropriate type of GUI screen prior to obtaining the image frame. In some implementations, control command generator 120 may be configured to generate a set of commands, such as a command blast, for transmission to the source device. The command blast may comprise a plurality of commands transmitted via any one or more of RF signal 126A, IR signal 128A, IP signal 116A, and/or control signal 108A to cause the source device to launch or navigate to a particular or predetermined GUI screen (e.g., the home screen or the like as described herein.). Additional details regarding the automatic navigation of a media device may be found in U.S. patent application Ser. No. 15/819,896, filed on Nov. 21, 2017 and entitled “Automatic Screen Navigation for Media Device Configuration and Control,” the entirety of which is incorporated by reference.

In some instances, because the identity of the source may be unknown to switching device 104, control command generator 120 may be configured to generate the command blast that includes commands for a plurality of media device types, brands, makes, models, versions, etc. As one illustrative example, the command blast may include one or more commands to navigate the source device to launch a home screen that is transmitted via IR transmitter 128 using a plurality of different IR transmission codes. Implementations are not limited to IR blasts, however, and may include any other command blast using one or more of the communication protocols described herein. In this manner, even if the source device may be unknown to switching device 104, a command blast may be transmitted to the source device causing the source device to launch or navigate to the predetermined GUI screen.

In step 404, the obtained image frame is converted to a reduced image frame. For instance, with reference to FIG. 1, image frame analyzer 122 may be configured to convert the image frame obtained from one of source device(s) 102A to be identified to a reduced image frame. In example embodiments, image frame analyzer 122 may be configured to convert the obtained image frame to a reduced image frame using similar techniques as described herein with respect to frame converter 306. For instance, image frame analyzer may convert the obtained image frame to a monochrome image, an image with a reduced number of colors, an image with a reduced resolution, a compressed image, etc.

For example, image frame analyzer 122 may be configured to convert and/or preprocess the obtained image frame such that the image frame has the same resolution, format (e.g., image type), etc. as the image stencil that may be stored on switching device 104. In another example, image frame analyzer 122 may convert the obtained image frame to a monochrome (e.g., black and white) image, such as where the image stencils are also in a black and white scheme or comprise monochrome images. In another implementation, the image frame that is obtained may be obtained in the same size or resolution as the size or resolution of the image stencils. In yet another example, image frame analyzer 122 may be configured to perform a cropping operation on the obtained image frame. In some other implementations, image frame analyzer 122 may be configured to obtain a plurality of image frames and preprocess the image frames to generate a single combined or average image frame (e.g., by averaging pixel values across the plurality of images). It is noted and understood, however, that the disclosed conversions and/or preprocessing techniques are illustrative in nature only, and may include any combination of the techniques described herein in any order, and/or any other techniques known and appreciated to those skilled in the art.

In step 406, the reduced image frame is compared with each of a plurality of image stencils in an image stencil set. For instance, with reference to FIG. 1, image frame analyzer 122 may configured to compare the reduced image frame with each of a plurality of image stencils in an image stencil set that may be stored in device storage 132 (and/or stored remotely in some implementations). In examples, each image stencil may comprise at least one static image region that is opaque and at least one dynamic image region that is transparent, as described herein. Each image stencil may also be associated with a particular media device type, brand, make, model, etc.) as described earlier.

Image frame analyzer 122 may compare the obtained image frame with one or more stencils in a set of stencils in various ways. In example embodiments, image frame analyzer 122 may compare the obtained image frame in any appropriate fashion, such as by comparing the obtained image frame with all of the image stencils in an iterative fashion, or by comparing the obtained image frame with each image stencil until it is determined that the image frame corresponds to a particular image stencil. Image frame analyzer 122 may compare the reduced image frame to each image stencil in the set of stencils (e.g. in an iterative fashion) by superimposing, combining, overlaying, etc. the image frame and each image stencil. For instance, image frame analyzer 122 may compare or combine the reduced image frame with each stencil by overlaying or copying the static image regions of the image stencil on the reduced image frame, and comparing that image with the original reduced image frame. Where the static image regions of the image stencil match regions in the reduced image frame, it may be determined that a high degree of similarity exists between the image stencil and the reduced image frame. In other implementations, image frame analyzer 122 may compare the reduced image frame and the image stencil by performing one or more image analysis techniques, such as comparing pixel locations and/or pixel values corresponding to the areas of the image representing the static image region(s) of the stencil. Because the dynamic regions of the image stencil are transparent, those regions are effectively not taken into account when comparing the reduced image frame to the image stencil.

In some other example embodiments, such as where the reduced image frame and/or image stencil comprise a high resolution and/or large file size, performance of image frame analyzer 122 may be enhanced in some ways. For example, image frame analyzer 122 may be configured to copy memory values (e.g., representing pixel values) of the opaque (e.g., non-transparent) image regions of the stencil representing the static image regions, and overwrite the memory values of a copy of the reduced image frame at the same regions with the copied values from the stencil. In other words, the static regions identified by the stencil may overwrite the same areas of the copy of the reduced image frame. After copying over such memory values representing the static regions of the stencil onto a copy of the reduced image frame, the copied image with the overwritten memory values may be compared with the original reduced image frame to determine the between the two images. In this way, because the values from the opaque regions are used, image frame analyzer 122 need not expend significant resources in comparing the dynamic or transparent regions identified by the stencil, thereby reduce the amount of processing required to compare the reduced image frame and the image stencil.

In step 408, it is determined that the reduced image frame matches an image stencil in the image stencil set. For instance, with reference to FIG. 1, image frame analyzer 122 may determine that the reduced image frame matches a particular image stencil in the image stencil set stored in storage device 132. Image frame analyzer 122 may determine that the reduced image frame matches a particular image stencil in various ways, such as by selecting the image stencil of the image stencil set with the highest degree of similarity when compared to the reduced image frame. For instance, where the static image region of the image stencil is the same or sufficiently similar (e.g., based on a similarity threshold) with the same regions in the reduced image, image frame analyzer 122 may determine that the reduced image frame matches the image stencil. In this manner, where the image stencil matches the reduced image frame (e.g., where visible differences do not result upon comparing the image stencil and the image frame), it may be determined that the image frame corresponds to the particular stencil.

In step 410, the media device is identified based on a device identifier associated with the matched image stencil. For instance, with reference to FIG. 1, image classifier 124 may be configured to identify the source media device (one of source device(s) 102A) from which the image frame was obtained based on a device identifier associated with the image stencil that was determined to match the reduced image frame.

In other words, in the illustrative system shown in FIG. 1, image frame classifier 124 may classify a reduced image frame, such as a home screen image obtained from one of source devices 102A as belonging to a class. For instance, with respect to FIG. 1, image classifier 124 may be configured to classify the image frame (and accordingly the device from which the image frame was obtained) as belonging to a particular device brand, make, model, type, version, etc. In some examples, image classifier 124 may comprise a mapping or correspondence table identifying a particular class (e.g., a type of GUI screen) associated with each image stencil in the set of image stencils. In this manner, the image frame (and accordingly, the device from which the image frame was obtained) may be classified and automatically identified.

Furthermore, as described above, such techniques may decrease the amount of memory and processing required to classify images (e.g., by utilizing image stencils in which regions of interest are identified using reduced image frames), thereby improving the speed and functionality of switching device 104 and outperforming other techniques of classifying images. For instance, using the techniques described herein, switching device 104 may perform a more accurate and quicker and quicker classification of images (and identification of coupled devices).

Furthermore, although implementations are described herein in which the generation of an image stencil, and/or utilization of an image stencil to identify a media device, may be based on converting an image frame obtained from a media device to a reduced image frame, implementations are not so limited. It is contemplated that in other implementations, converting an obtained image frame to a reduced image frame need not be performed. Rather, in such instances, the generation and/or subsequent utilization of an image stencil may be carried out using the obtained image frame, rather than a reduced image frame as described herein.

Furthermore, although it is described herein that static image classification system 114 may be implemented in a media hub or switching device, or the like, to identify coupled devices, it is contemplated that static image classification system 114 may be implemented across various other domains, systems or devices. For instance, static image classification system 114 may be configured to classify logos, icons, shapes, etc. for identifying applications on a GUI screen, or any other image that may comprised a fixed structure of static and/or dynamic image elements.

C. Example Stencil Generation Embodiments

As described above, techniques described herein may be used to generate image stencils for images obtained from devices, such as media devices that may be coupled in a home entertainment system. For instance, FIGS. 5A-5C, 6A-6C, 7, and 8 depict examples of stencil generation techniques described herein. The stencil generation techniques shown in FIGS. 5A-5C, 6A-6C, 7, and 8 may be carried out by static image classification system 114 as described herein. The examples in FIGS. 5A-5C, 6A-6C, 7, and 8 are illustrative only, and not intended to be limiting.

For instance, FIGS. 5A-5C depict illustrative image frames 500, 510, 520 representing GUI screens comprising dynamic and static components, in accordance with example embodiments described herein. GUI screens depicted in FIG. 5A-5C may comprise, for example, image frames obtained from a media device. In the example shown, the images may comprise various image frames of a home screen or a default screen of a GUI of a media streaming device, such as AppleTV™, although implementations may also include any other multimedia devices, such as a cable/satellite set-top box (STB), video game consoles such as Xbox™ or Playstation™, other media streaming devices, such as Roku™, Chromecast™, and a host of other devices, such as Blu-ray™ players, digital video disc (DVD) and compact disc (CD) players.

With respect to FIG. 5A, GUI screen 502 may include various image elements, such as icons, graphics, text, colors, etc. For example, GUI screen 502 may include content frames 504a-504d, which may depict interactive objects that illustrate multimedia content (e.g., television shows, movies, games, etc.) that may be selected upon interaction. In some example implementations, one or more of content frames 504a-504d may be configured to present still images (e.g., a cover photo or a still image from a scene in a television show) or present a series of images (e.g., a video clip or animation). GUI screen 502 may also comprise app logos 506a-506e, which may depict interactive objects (e.g., logos of selectable applications) that illustrate applications that may be executed upon selection by a user.

FIG. 5B illustrates a GUI screen 512 that includes a rendering of a screen of a GUI of a media device. For instance, in GUI screen 512, an advertisement 514 may be presented in place of some or all of content frames 504a-504d, while app logos 506a-506e may be presented in the same arrangement as shown in GUI screen 502. Similarly, in FIG. 5C, a GUI screen 522 is depicted in which a device logo 524 (e.g., a logo of the source media device from which GUI screen 520 is obtained) is presented in place of content frames 504a-504d, or advertisement 514. However, in the illustrative arrangement shown in FIG. 5C, app logos 506a-506e may still be presented in the same arrangement as shown in GUI screen 502 and GUI screen 512.

Thus, as shown in FIGS. 5A-5C, different GUI screens may be captured, each comprising a different rendering of the same type of GUI screen (e.g., a home screen of a media device). Although each of the illustrative GUI screens depicted in FIGS. 5A-5C represent a home screen of the same type of media device, different content offerings, arrangement of elements, etc. may be present on the home screen, resulting in differences across the images in certain regions (e.g., dynamic regions), and similarities in other regions (e.g., static regions). It is noted that the arrangements depicted in FIGS. 5A-5C is illustrative only, and may include any type of arrangement or number of objects. Those skilled in the art will appreciate that other types of screen arrangements are also contemplated, such as where different content frames are depicted instead of content frames 504a-504d, a different advertisement is shown, or may include additional or fewer graphical elements than those shown in FIGS. 5A-5C.

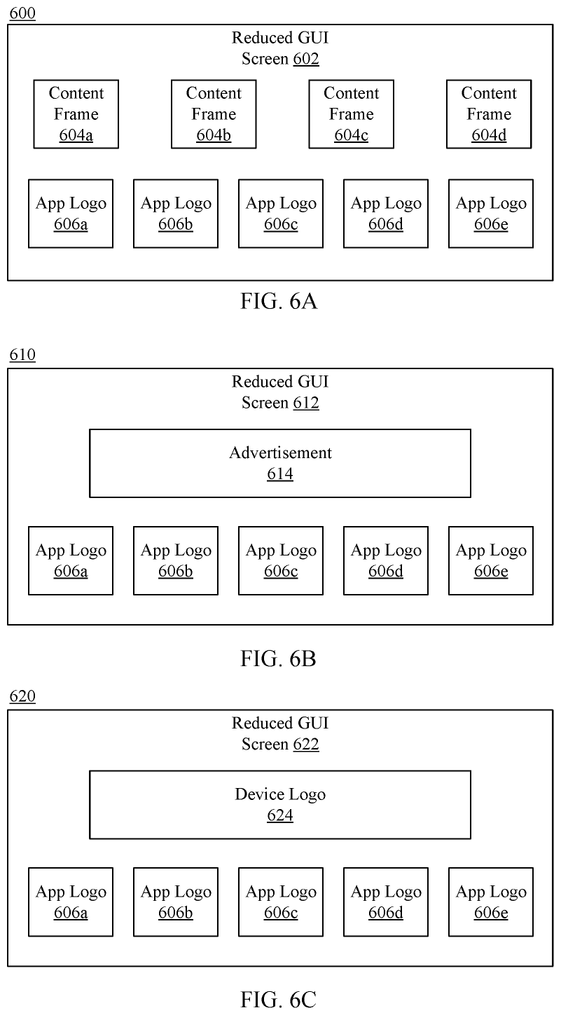

FIGS. 6A-6C depict illustrative reduced image frames 600, 610, 620 comprising dynamic and static regions described above after applying one or more image processing techniques to images shown in FIGS. 5A-5C, respectively, in accordance with example embodiments described herein. For instance, the image processing techniques may comprise a conversion of each of image frames 500, 510, 520 from a color image frame to a monochrome (e.g., black and white) image frame, although other techniques are also contemplated as described herein. Images depicted in FIGS. 6A-6C may undergo or more additional or alternative processing techniques, such as a thresholding operation, a cropping operation, an image format conversion operation, an image resizing operation, etc.

Accordingly, in examples, reduced image frame 600 may comprise a conversion of image frame 500, in which a reduced GUI screen 602 is generated therefrom. Reduced GUI screen 602 may include content frames 604a-604d and app frames 604a-604d that are similar to content frames 504a-504d and app logos 506a-506e, respectively, but in a reduced format (e.g., in a monochrome format in some illustrative examples). Similarly, reduced GUI screen 612 may comprise an advertisement 614 and app frames 604a-604d that are similar to advertisement 514 and app logos 506a-506e, but in a reduced format. Furthermore, reduced GUI screen 622 may comprise a device logo 624 and app logos 606a-606e that are similar to device logo 524 and app logos 506a-506e, but in a reduced format. Such processing may reduce image sizes, which may reduce processing requirements and increase the efficiency at which a stencil may be generated.

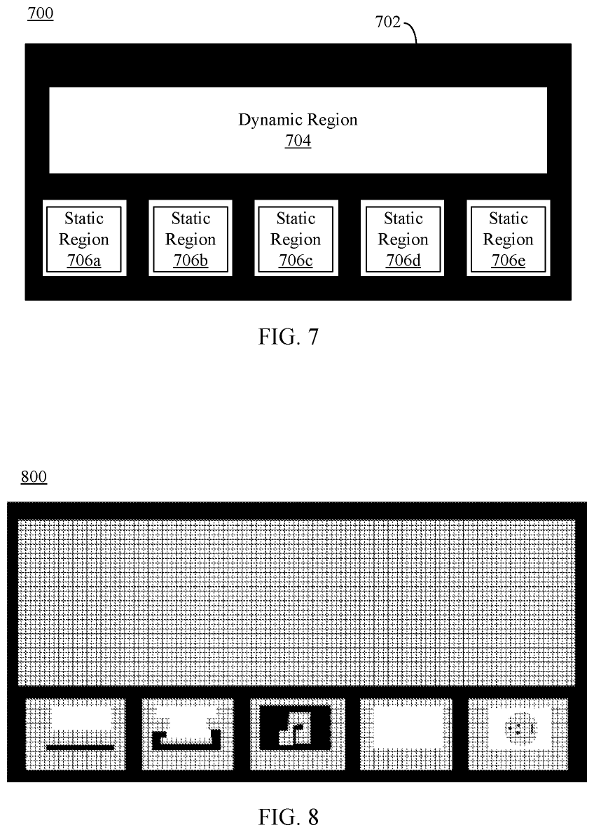

FIG. 7 depicts an illustrative image stencil 700 of a GUI screen 702 comprising a plurality of regions of interest, including dynamic region 704 and a plurality of static regions 706a-706e. In the example shown in FIG. 7, dynamic region 704 may be identified as a dynamic region due to the different objects, icons, etc. that may be presented in that region across various renderings of the same type of GUI screen (e.g., as shown in reduced GUI screens 602, 612, 622). Furthermore, static regions 706a-706e may be identified as static image regions due to the same objects that are presented in those regions across various renderings of the same type of GUI screen. In other words, dynamic region 704 of image stencil 700 may comprise regions where the content of a particular type of screen may change across different renderings, while static regions 706a-706e may comprise regions where the content remains static across the different renderings.

FIG. 8 depicts another illustrative image stencil that may be generated in accordance with examples. As shown in FIG. 8, image stencil 800 may comprise different regions, illustrated by cross-hatched areas, white areas, and black areas. Cross-hatched areas may represent transparent regions of image stencil 800 (e.g., dynamic regions), while the white and black regions may represent the opaque static regions in a monochrome format. For example, FIG. 8 may illustrate an image stencil that may be generated by combining a plurality of the images shown in FIGS. 5A-5C and 6A-6C (e.g., by averaging or the like). Based on an identification of static image elements (e.g., static regions) and dynamic image elements (e.g., dynamic regions) across the set of images shown in FIGS. 5A-5C and 6A-6C, one or more static regions may be set as opaque regions in image stencil, and one or more dynamic regions may be set as a transparent regions (indicated by the cross-hatched areas). Furthermore, a structure or layout of elements on the GUI screen may be indicated as a static region, depicted by the black grid-like pattern in FIGS. 7 and 8.

As discussed herein, opaque image regions may include areas that contain static image elements across the images shown in FIGS. 5A-5C and 6A-6C, while transparent regions include areas that contain dynamic image elements across the images shown in FIGS. 5A-5C and 6A-6C. Transparent image regions may be identified by an alpha channel or any other suitable manner for identifying a transparent region in an image file.

In some example embodiments, FIG. 8 may comprise an image stencil after one or more additional image processing and/or alteration techniques are implemented. In some examples, FIG. 8 may illustrate a final image stencil using one or more manual and/or automated noise reduction techniques. Such techniques may enable the generated stencil to eliminate false positives or negatives during the comparison steps described above, thereby enhancing the accuracy of the image classification. For instance, as shown in FIG. 8, the transparent region representing dynamic image elements across the set of images may be enlarged compared to an initial stencil to remove any noise that may remain after certain processing techniques were applied to generate the initial image stencil.

In example implementations, the generated image stencil (e.g., as shown in either of FIG. 7 or 8) may be stored on a server and/or a media device, such as switching device 104, along with a device identifier that identifies the media device. For instance, in the example shown in FIG. 7 or 8, the image stencil may be mapped or classified as an image stencil associated with an AppleTV™ media streaming device, although any other type of media device is contemplated.

As described above, when a switching device, such as switching device 104, is coupled to an AppleTV™ device for the first time, static image classification system 114 may be configured to obtain an image frame from the media device and compare it with a set of stencils to determine that the image frame corresponds to a particular one of the stencils (e.g., the stencil shown in FIG. 8 for example). As described above, one or more of such image stencils may be stored locally on switching device 104. In some implementations, the image stencils may be obtained from a server (e.g., where image stencils may be generated) over a network via network interface 116. In this manner, therefore, the device from which the image frame is obtained may be classified and identified as an AppleTV™ media streaming device in an automated fashion.

### III. Computer System Implementation

Any of the systems or methods (or steps therein) of FIGS. 1-8 and/or the components or subcomponents included therein and/or coupled thereto may be implemented in hardware, or any combination of hardware with software and/or firmware. For example, the systems or methods of FIGS. 1-8 and/or the components or subcomponents included therein and/or coupled thereto may be implemented as computer program code configured to be executed in one or more processors. In another example, the systems or methods FIGS. 1-8 and/or the components or subcomponents included therein and/or coupled thereto may be implemented as hardware (e.g., hardware logic/electrical circuitry), or any combination of hardware with software (computer program code configured to be executed in one or more processors or processing devices) and/or firmware.

The embodiments described herein, including systems, methods/processes, and/or apparatuses, may be implemented using well known servers/computers, such as computer 900 shown in FIG. 9. For example, the systems or methods of FIGS. 1-8 and/or the components or subcomponents included therein and/or coupled thereto, including each of the steps of flowchart 200 and/or flowchart 400 can each be implemented using one or more computers 900.

Computer 900 can be any commercially available and well-known computer capable of performing the functions described herein, such as computers available from International Business Machines, Apple, Sun, HP, Dell, Cray, etc. Computer 900 may be any type of computer, including a desktop computer, a server, etc.

As shown in FIG. 9, computer 900 includes one or more processors (also called central processing units, or CPUs), such as a processor 906. Processor 906 may include any part of the systems or methods of FIGS. 1-8 and/or the components or subcomponents included therein and/or coupled thereto, for example, though the scope of the embodiments is not limited in this respect. Processor 906 is connected to a communication infrastructure 902, such as a communication bus. In some embodiments, processor 906 can simultaneously operate multiple computing threads.

Computer 900 also includes a primary or main memory 908, such as random-access memory (RAM). Main memory 908 has stored therein control logic 924 (computer software), and data.

Computer 900 also includes one or more secondary storage devices 910. Secondary storage devices 910 include, for example, a hard disk drive 912 and/or a removable storage device or drive 914, as well as other types of storage devices, such as memory cards and memory sticks. For instance, computer 900 may include an industry standard interface, such a universal serial bus (USB) interface for interfacing with devices such as a memory stick. Removable storage drive 914 represents a floppy disk drive, a magnetic tape drive, a compact disk drive, an optical storage device, tape backup, etc.

Removable storage drive 914 interacts with a removable storage unit 916. Removable storage unit 916 includes a computer useable or readable storage medium 918 having stored therein computer software 926 (control logic) and/or data. Removable storage unit 916 represents a floppy disk, magnetic tape, compact disc (CD), digital versatile disc (DVD), Blu-ray™ disc, optical storage disk, memory stick, memory card, or any other computer data storage device. Removable storage drive 914 reads from and/or writes to removable storage unit 916 in a well-known manner.

Computer 900 also includes input/output/display devices 904, such as monitors, keyboards, pointing devices, etc.

Computer 900 further includes a communication or network interface 920. Communication interface 920 enables computer 900 to communicate with remote devices. For example, communication interface 920 allows computer 900 to communicate over communication networks or mediums 922 (representing a form of a computer useable or readable medium), such as local area networks (LANs), wide area networks (WANs), the Internet, etc. Network interface 920 may interface with remote sites or networks via wired or wireless connections. Examples of communication interface 922 include but are not limited to a modem, a network interface card (e.g., an Ethernet card), a communication port, a Personal Computer Memory Card International Association (PCMCIA) card, etc.

Control logic 928 may be transmitted to and from computer 900 via the communication medium 922.

Any apparatus or manufacture comprising a computer useable or readable medium having control logic (software) stored therein is referred to herein as a computer program product or program storage device. This includes, but is not limited to, computer 900, main memory 908, secondary storage devices 910, and removable storage unit 916. Such computer program products, having control logic stored therein that, when executed by one or more data processing devices, cause such data processing devices to operate as described herein, represent embodiments described herein.

Devices in which embodiments may be implemented may include storage, such as storage drives, memory devices, and further types of computer-readable media. Examples of such computer-readable storage media include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may store program modules that include computer program logic for implementing any part of the systems or methods of FIGS. 1-8 and/or the components or subcomponents included therein and/or coupled thereto, including flowcharts 200 and/or 400, and/or further embodiments described herein. Embodiments are directed to computer program products comprising such logic (e.g., in the form of program code, instructions, or software) stored on any computer useable medium. Such program code, when executed in one or more processors, causes a device to operate as described herein.

Note that such computer-readable storage media are distinguished from and non-overlapping with communication media. Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Example embodiments are also directed to such communication media.

It is noted that while FIG. 9 shows a server/computer, persons skilled in the relevant art(s) would understand that embodiments/features described herein could also be implemented using other well-known processor-based computing devices, including but not limited to, smart phones, tablet computers, netbooks, gaming consoles, personal media players, and the like.

### IV. Conclusion

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described exemplary embodiments, but should be defined only in accordance with the following claims and their equivalents.

What is claimed is:

1. A method of generating an image stencil for a media device, the method comprising:
obtaining a plurality of image frames from the media device;
converting, for each of the obtained image frames, the obtained image frame to a reduced image frame, to generate a plurality of reduced image frames from the obtained image frames;
identifying regions of interest across the reduced image frames, the regions of interest including at least a first image region that includes an area that is static across the reduced image frames and a second image region that includes an area that is dynamic across the reduced image frames;
generating the image stencil using the regions of interest, where the image stencil is opaque in at least the first image region and is transparent in at least the second image region; and
storing the image stencil along with an identifier of the media device.

2. The method of claim 1, wherein said converting the image frame to a reduced image frame comprises converting the image frame to a monochrome image frame.

3. The method of claim 1, wherein the converting the obtained image frame to a reduced image frame comprises reducing a resolution of the obtained image frame.

4. The method of claim 1, wherein the obtained image frames are obtained from a graphical user interface (GUI) screen of the media device.

5. The method of claim 4, wherein the GUI screen of the media device comprises at least one of a home screen or a guide screen of the media device.

6. The method of claim 1, wherein the image stencil comprises an alpha channel that includes at least the second image region.

7. The method of claim 1, wherein the image stencil is transmitted to a plurality of media device hubs over a network.

8. A system for generating an image stencil for the media device, the system comprising:
one or more processors; and
one or more memory devices that store program code configured to be executed by the one or more processors, the program code comprising instructions for:
an image frame obtainer configured to obtain a plurality of image frames from the media device;
a frame converter configured to, for each of the obtained image frames, convert the image frame, to a reduced image frame to generate a plurality of reduced image frames from the obtained image frames;
a region of interest identifier configured to identify regions of interest across the reduced image frames, the regions of interest including at least a first image region that includes an area that is static across the reduced image frames and a second image region that includes an area that is dynamic across the reduced image frames;
a stencil creator configured to generate the image stencil using the regions of interest, where the image stencil is opaque in at least the first image region and is transparent in at least the second image region.
a storage device for storing the image stencil along with an identifier of the media device.

9. The system of claim 8, wherein the frame converter is configured to convert the obtained image frame by at least converting the obtained image frame to a monochrome image frame.

10. The system of claim 8, wherein the frame converter is configured to convert the obtained image frame by at least reducing a resolution of the image frame.

11. The system of claim 8, wherein the image frame obtainer is configured to obtain the obtained image frames from a graphical user interface (GUI) screen of the media device.

12. The system of claim 11, wherein the GUI screen of the media device comprises at least one of a home screen or a guide screen of the media device.

13. The system of claim 8, wherein the image stencil comprises an alpha channel that includes at least the second image region.

14. The system of claim 8, further comprising a stencil transmitter configured to transmit the image stencil to a plurality of media device hubs over a network.

15. A method of identifying a media device, the method comprising:
obtaining the image frame from the media device;
converting the obtained image frame to a reduced image frame;
comparing the reduced image frame with each of a plurality of image stencils in an image stencil set, each image stencil comprising at least one static image region that is opaque and at least one dynamic image region that is transparent;
determining that the reduced image frame matches an image stencil in the image stencil set; and
identifying the media device based on a device identifier associated with the matched image stencil.

16. The method of claim 15, wherein the obtained image frame comprises at least one of a home screen image or a guide screen image of the media device.

17. The method of claim 15, further comprising:
transmitting a control command to cause the media device to navigate to a predetermined screen prior to said obtaining the image frame from the media device.

18. The method of claim 15, wherein said converting the image frame to a reduced image frame comprises converting the obtained image frame to a monochrome image.

19. The method of claim 15, wherein said converting the image frame to a reduced image frame comprises reducing a resolution of the obtained image frame.

20. The method of claim 15, wherein at least one image stencil in the image stencil set is received from a server over a network.
